(19) United States
(12) Patent Application Publication
(10) Pub. No.: US 2008/0083702 A1
(43) Pub. Date: Apr. 10, 2008

(54) Method for manufacturing an electron emitting device and method for manufacturing an electron tube

(75) Inventors: Fumiaki Kataoka, Chiba (JP); Youhei Fujimura, Chiba (JP); Takeshi Tonegawa, Chiba (JP); Yasumoto Kubo, Chiba (JP); Hiroaki Eguchi, Chiba (JP); Shigeo Itoh, Chiba (JP); Tatsuo Yamaura, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 11/905,865

(22) Filed: Oct. 5, 2007

(30) Foreign Application Priority Data
Oct. 6, 2006 (JP) 2006-274682

(51) Int. Cl. B05D 1/00; B01J 19/00

(52) U.S. Cl. 216/58; 427/532; 445/26

(57) ABSTRACT

A method for manufacturing an electron emitting device includes disposing a cathode substrate and an anode substrate to be faced to each other in a depressurized atmosphere containing an activation gas, the cathode substrate including a carbon layer formed by applying a paste having a fibrous carbon and carbon impurities on a cathode conductor and drying the coated paste. The method further includes applying a reverse bias voltage to the cathode conductor of the cathode substrate and an anode conductor of the anode substrate, thereby activating the carbon layer.

### FIELD OF THE INVENTION

The present invention relates to a method for manufacturing an electron emitting device of an electric field emission type, which is used in an electron tube including a display apparatus such as a fluorescent display tube, a fluorescent luminous tube for a print head, an image pickup tube or the like, and to a method for manufacturing an electron tube.

### BACKGROUND OF THE INVENTION

There is known a fluorescent display tube, a fluorescent luminous tube or the like which adopts, as an electron source for emitting a light from a phosphor of an anode substrate, an electron emitting device of a field emission type formed of a fibrous carbon such as a monolayered carbon nanotube, a multilayered carbon nanotube or the like. In this case, the electron emitting device is generally manufactured by dispersing fibrous carbon produced through arc discharge in a solvent to make a paste, which is then coated on a cathode conductor. When the fibrous carbon is formed by arc discharge, carbon impurities are also produced together therewith, and thus the paste includes not only the fibrous carbon but also the carbon impurities dispersed therein. Accordingly, the fibrous carbon which contributes to the electron emission is covered with the carbon impurities, making it difficult to obtain a sufficient electron emission.

Therefore, there are proposed activation methods for increasing the number of emission sites of the electron emission by exposing the fibrous carbon which is covered with the carbon impurities. With reference to FIGS. 6A to 6C, the conventional activation method will be described.

As illustrated in FIG. 6A, a cathode conductor 12 is formed on a glass substrate 11 and, then, a carbon layer 13 is formed by applying a paste including a mixture of fibrous carbon and carbon impurities on the cathode conductor 12, thereby manufacturing a cathode substrate 1. Adhesive tape (not shown) is attached to the carbon layer 13 and is then pealed off, so that parts of the carbon impurities of the surface region of the carbon layer 13 is eliminated to thus roughen (damage) the surface, thereby exposing fibrous carbon portions 141 and 142, as shown in FIG. 6B (see, for example Japanese Patent Laid-open Application No. 2001-35360).

Further, there is a method for exposing fibrous carbon portions 141 and 142 by applying a hot melten resin on the carbon layer 13, thus attaching the resin to the carbon layer 13 by heating, and then removing it. (see, for example Japanese Patent Laid-open Application No. 2004-335435) Furthermore, there is disclosed a method for exposing the fibrous carbon portions 141 and 142 by plasma etching. (see, for example Japanese Patent Laid-open Application No. 2000-311578)

As shown in FIG. 6B, the activated cathode substrate 1 includes a long fibrous carbon portion 141 and a short fibrous carbon portion 142. When a display apparatus, for example, a fluorescent display tube, is manufactured by using the cathode substrate 1 in which the long and short fibrous carbon portions are present together, an electric field is concentrated on to the long fibrous carbon portion 141, so that an amount of the electrons emitted from the long fibrous carbon portion 141 is greater than that from the short fibrous carbon portion 142. As a result, the emission luminance of the phosphor becomes non-uniform and thus, parts of the high luminance and parts of low luminance are co-present. That is, since the emission luminance at the part of the phosphor facing the long fibrous carbon portion 141 is higher than that of the other part of the phosphor facing the short fibrous carbon portion 142, light is emitted in a form of luminescent spots, thereby deteriorating the display quality of the fluorescent display tube.

Therefore, in order to render uniform the amount of the electrons emitted from the fibrous carbon, uniformization methods for making the length of the fibrous carbon uniform as shown in FIG. 6C have been proposed. As such a uniformization method, there is disclosed a method of arranging the cathode substrate 1 in FIG. 6B and an anode substrate (not shown) having an anode conductor to be faced to each other, and emitting electrons by applying voltage which is higher than a typical voltage for driving a fluorescent display tube, to the cathode conductor 12 and the anode conductor, thereby burning and removing end portions of the long fibrous carbon portion 141 by using Joule heat of the emitted electrons (see, for example Japanese Patent Laid-open Application No. 2006-12578). Alternatively, a reaction gas, including O₂, H₂, CO₂, or H₂O is introduced to the above arrangement to etch and remove end portions of the long fibrous carbon portion 141 (see, for example Japanese Patent Laid-open Application No. 2002-150929).

In the conventional activation methods, exposure of the fibrous carbon is low, resulting in an insufficient number of emission sites. That is, although the method of using the adhesive tape or applying the hot melten resin is intended to roughen or damage the surface region of the carbon layer by removing the adhesive tape or the coating film to thereby expose the fibrous carbon, the exposure thereof is insufficient. Further, since the fibrous carbon and the carbon impurities are the similar carbon-based materials, the method using plasma etching makes it difficult to selectively expose the fibrous carbon.

### SUMMARY OF THE INVENTION

In view of the problems accompanied with the conventional activation and uniformization methods, the present invention provides an activation method capable of increasing the number of emission sites of an electron emitting device compared to the conventional activation method, and further provides a method capable of performing the activation method and a uniformization method in a same process.

In accordance with an aspect of the present invention, there is provided a method for manufacturing an electron emitting device including: disposing the cathode substrate and an anode substrate to be faced to each other in a depressurized atmosphere containing an activation gas, the cathode substrate including a carbon layer formed by applying a paste having a fibrous carbon and carbon impurities on a cathode conductor and drying the coated paste; and applying a reverse bias voltage to the cathode conductor of the cathode substrate and an anode conductor of the anode substrate, thereby activating the carbon layer.

The anode substrate may be manufactured by forming the anode conductor on a glass substrate and attaching a phosphor to the anode conductor.

The method for manufacturing an electron emitting device further including: disposing a cathode substrate a carbon layer of which is activated by the above-described method and another anode substrate to be faced to each other in another depressurized atmosphere; and applying a forward bias voltage to the cathode conductor of said another cathode substrate and an anode conductor of the anode substrate, thereby uniformizing the fibrous carbon.

Said another anode substrate may be manufactured by forming the anode conductor on a glass substrate and attaching a phosphor to the anode conductor.

The fibrous carbon may be uniformized by introducing a reaction gas into said another depressurized atmosphere.

The depressurized atmosphere for uniformization is identical to the depressurized atmosphere for activation.

In accordance with another aspect of the present invention, there is provided a method for manufacturing a fluorescent display tube, including: sealing and attaching a cathode substrate having the electron emitting device manufactured by the above-described method to an anode substrate having an anode conductor and a phosphor attached thereto by using a sealing material.

The activation method in accordance with the first aspect of the present invention can increase the number of emission sites by activating a carbon layer by means of applying reverse bias voltage between a cathode substrate and an anode substrate in a depressurized atmosphere containing an activation gas. Moreover, the activation method in accordance with the first aspect of the present invention may further increase the activation effect when combined with a conventional activation method.

The anode substrate used for the activation method in the present invention may be an anode substrate used only for the activation or may be an anode substrate having a phosphor attached thereto. Thus, in case where the anode substrate for only activation is used, the mass production of an electron emitting device may be easily realized in the process only for activating an electron emitting device before a final product such as a fluorescent display tube is manufactured. Alternatively, in case where the anode substrate having a phosphor attached thereto is used, the electron emitting device may be activated in the process for assembling (manufacturing) a final product such as a fluorescent display tube. In this case, the additional activation process can be omitted.

The activation method and the uniformization method in accordance with the first aspect of the present invention may use same kinds of activation and uniformization gases and apply a reverse bias voltage or forward bias voltage to the cathode substrate and the anode substrate thereby performing the activation treatment and uniformization treatment. That is, the two methods may be realized by using the same apparatus.

In the electron emitting device manufactured by using the activation method and uniformization method in accordance with the first aspect of the present invention, the number of emission sites is increased and the length of the fibrous carbon becomes uniform. Hence, when a fluorescent display tube is manufactured by using the electron emitting device manufactured in accordance with the aspects of the present invention, it exhibits high emission luminance and uniform light emission without stains (or luminescent spots), resulting in high display quality.

### BRIEFING DESCRIPTION OF THE DRAWINGS

The objects and features of the present invention will become apparent from the following description of embodiments given in conjunction with the accompanying drawings, in which:

FIGS. 1A to 1D depict a method of activating an electron emitting device in accordance with an embodiment of the present invention;

FIGS. 2A to 2C illustrate a method of uniformizing the electron emitting device in accordance with the embodiment of the present invention;

FIGS. 3A to 3D present methods of activating and uniformizing the electron emitting device in accordance with a second embodiment of the present invention;

FIGS. 4A and 4B show scanning electron micrographs (SEMs) respectively illustrating the surfaces of the electron emitting devices activated by using the activation method in accordance with the embodiment of the present invention and a conventional activation method;

FIG. 5 presents the numbers of luminescent spots in the emission dots of display devices treated by a conventional and inventive methods; and

FIGS. 6A to 6C depict a conventional activation method.

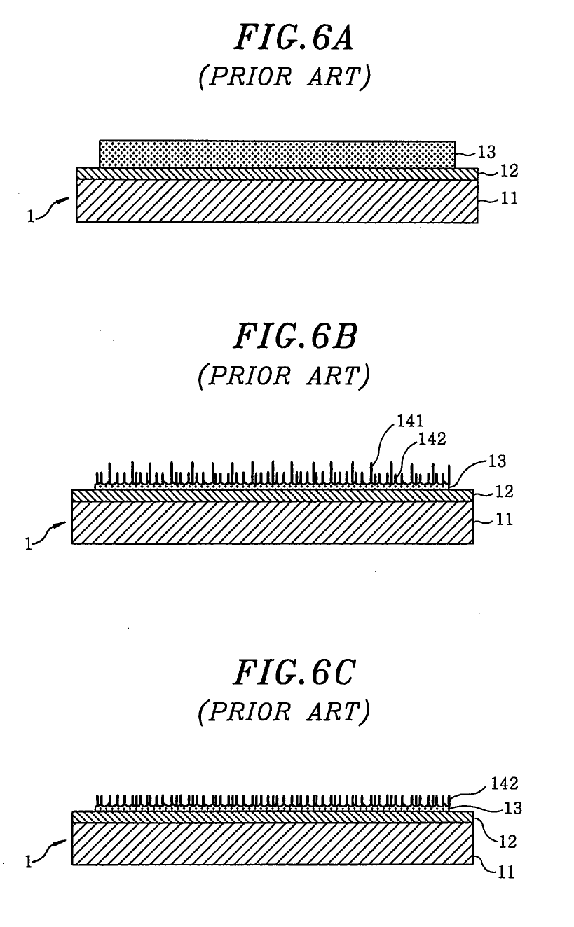

### DETAILED DESCRIPTION OF THE EMBODIMENTS

Hereinafter, embodiments of the present invention will be described with reference to the accompanying drawings that form a part hereof. In the drawings, like parts are designated by like reference numerals.

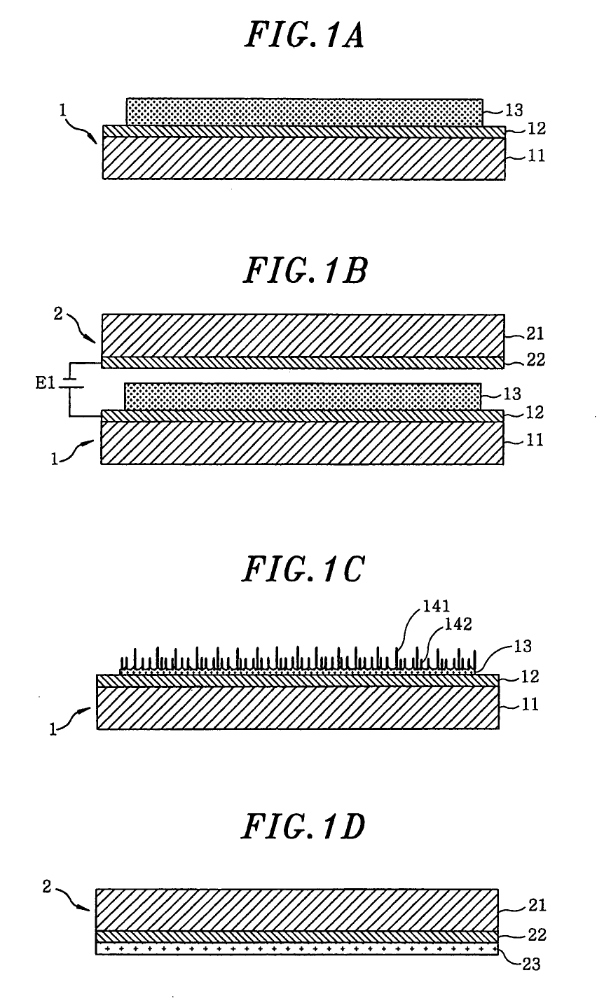

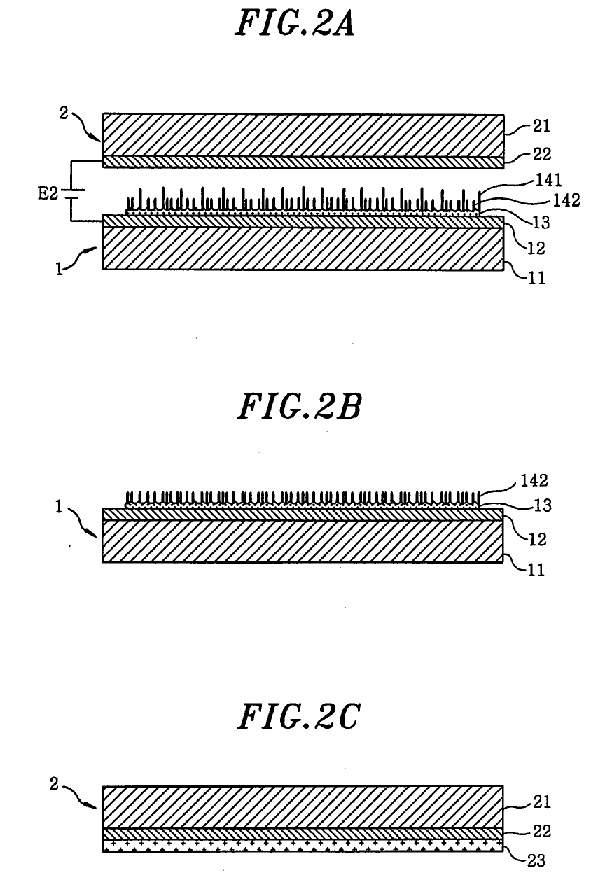

FIGS. 1A to 2C illustrate methods for activating and uniformizing an electron emitting device in accordance with an embodiment of the present invention.

First, the activation method of FIGS. 1A to 1D will be described below.

As illustrated in FIG. 1A, a cathode substrate 1 includes a glass (insulating) substrate 11, a cathode conductor 12 formed thereon and a carbon layer 13 formed by applying on the cathode conductor 12 and drying a paste including a mixture of fibrous carbon and carbon impurities. The paste is obtained by dispersing the mixture of the fibrous carbon and carbon impurities in a solution in which in an ethylcellulose (binder) is dissolved in terpineol.

As illustrated in FIG. 1B, the activation method is performed by using the cathode substrate 1 and an anode substrate 2. The anode substrate 2 includes a glass (insulator) substrate 21 and an anode conductor 22 formed thereon.

The anode substrate 2 and the cathode substrate 1 are disposed to be faced to each other in a depressurized atmosphere containing an activation gas (e.g., in a vacuum chamber). In that state, a positive voltage of a power supply El is applied to the cathode conductor 12, and a negative voltage thereof is applied to the anode conductor 22. That is, a reverse bias voltage is applied to the cathode conductor 12 and the anode conductor 22. When the reverse bias voltage is applied to the two conductors, the surface of the carbon layer 13 is roughened, thereby exposing fibrous carbon portions 141 and 142 as shown in FIG. 1C.

Although the anode substrate 2 in FIG. 1B includes the glass substrate 21 and the anode conductor 22 formed thereon, the substrate and the conductor may be formed of one metal body. In case where the anode substrate 2 is metal, its surface facing the cathode substrate 1 may be processed to have a shape suitable for the activation treatment, for example, a flat surface, a porous surface, a nano-imprinted irregular surface or the like.

As the anode substrate 2 in FIG. 1B, an anode substrate 2 having the anode conductor 22 and a phosphor 23 attached thereto can be used as shown in FIG. 1D. In this case, the cathode substrate 1 and the anode substrate 2 correspond to those of a fluorescent display tube. Therefore activation treatment may be conducted in a state in which both substrates are overlapped with each other by applying a sealing material such as a frit glass on the inner surfaces in the peripheries of both substrates and are kept in one body (i.e., a surface attachment) by a jig (a sealing clip), or bonded (i.e., a sealing attachment) by heating and softening the sealing material. That is, in the process of manufacturing the fluorescent display tube, the activation treatment can be conducted.

The activation gas used for the activation treatment of FIG. 1B may be any one or a mixture of two or more gases selected from O₂, H₂, CO₂, H₂O, air, a non-reactive gas (e.g., He, Ar, N₂) and the like. Further, monolayered carbon nanotube, multilayered carbon nanotube, carbon fiber, carbon nano-coil, carbon particles or the like can be exemplified as the fibrous carbon.

Since the reverse bias voltage is applied to the cathode conductor 12 and the anode conductor 22 in the activation treatment, electrons are not emitted from the fibrous carbon portions 141 and 142. Further, the power supply E1 may be a DC power supply or a pulse power supply.

When the activation treatment of FIG. 1B is performed, the cathode substrate 1 in FIG. 1C can be manufactured in a vacuum chamber dedicated only for activation, before assembling the cathode substrate 1 and the anode substrate 2 of the florescent display tube or the like, thereby making it possible to fabricate a large number of cathode substrate 1 simultaneously. On the other hand, if the activation treatment is performed in the course of manufacturing the fluorescent display tube or the like (i.e., after assembling the cathode substrate 1 and anode substrate 2), an additional activation process is no longer required, thereby simplifying the overall process of manufacturing the fluorescent display tube or the like.

Although the activation method of FIG. 1B directly activates the carbon layer 13, the method may be combined with the conventional activation method applying adhesive tape. That is, the fibrous carbon portions 141 and 142 may be exposed by using the adhesive tape and may be further exposed through the method of FIG. 1B.

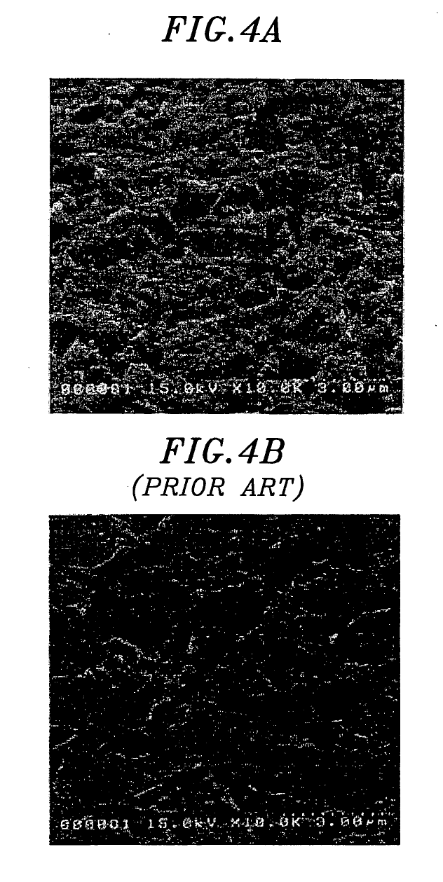

Referring to FIGS. 4A and 4B, illustrated SEM (Scanning Electron Microscope) images of the surfaces of the activated carbon layers.

FIG. 4B illustrates the SEM image of the carbon layer which was obtained by the conventional activation treatment using the adhesive tape, and FIG. 4A presents the SEM image of the carbon layer which was obtained by the conventional activation treatment using the adhesive tape and the activation treatment of FIG. 1B performed thereafter.

Comparing the SEM images in FIGS. 4A and 4B, it can be seen that the surface of the carbon layer in FIG. 4A is more favorably roughened or damaged than the surface of the carbon layer in FIG. 4B. That is, it can be seen that the activation method of FIG. 1B is effective for activating the carbon layer. Further, it can be seen that when the activation method of FIG. 1B is used in combination with the conventional activation method using adhesive tape, the activating effect can be further increased.

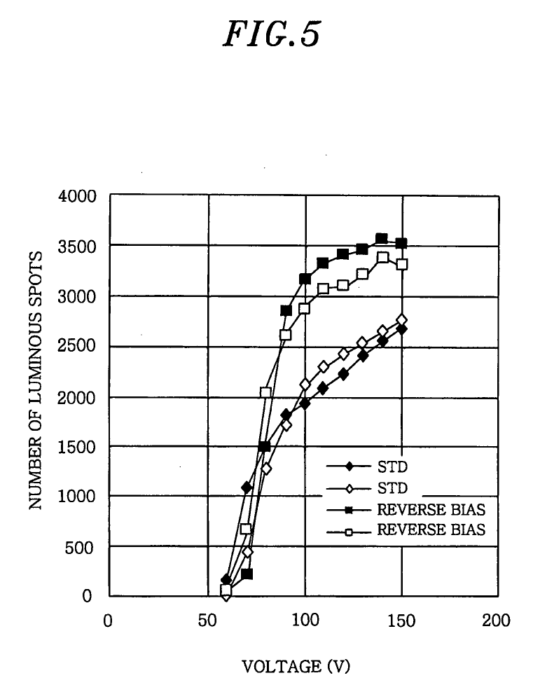

Referring to FIG. 5, the numbers of luminous spots in the emission dots of a display device are compared, depending on whether or not the activation treatment of the present embodiment is applied. In FIG. 5, the numbers of luminous spots in a dot (dot size 3 mm×4 mm) provided in a simple matrix type diode display device having a cross sectional structure in which a phosphor is attached to an anode were compared. The ‘STD’ in FIG. 5 shows the measured results from two dots in a sample of which a panel was formed through activation treatment by using the conventional adhesive tape. The ‘reverse bias’ in the FIG. 5 shows the measured results from two dots in a sample of which a panel was formed by the activation treatment using adhesive tape and the activation treatment of FIG. 1B thereafter. As the activating gas, air was used.

For measurement, line resistance R=10 kΩ was applied to the measurement line, pulse frequency was set to about 120 Hz with Du= 1/16 ms, and the anode voltage was increased from 60 V by a step of 10 V. In this condition, the luminous spots in the dots were measured. The number of luminescent spots was counted by taking the pictures thereof with a digital camera, performing binarization of the image by using a predetermined threshold and applying the obtained binary data to an image analysis software program which is commercially available.

Comparing the ‘STD’ with the reverse bias, it can be seen that there is no difference therebetween at the anode voltage in the range from about 60 V to 80 V, but the number of luminous spots (that is, the number of electron emitting points) is drastically increased in the ‘reverse bias’ at the anode voltage exceeding 80 V. That is, the activation method of FIG. 1B can be seen to be effective in activating the carbon layer.

In FIG. 1B, it is preferred that the cathode substrate 1 and the anode substrate 2 be disposed in a parallel manner. However, these substrates can be deviated from parallel relationship. If the two substrates are off the parallel relationship, the activation treatment results in non-uniformity. Hence, in FIG. 1B, when the cathode substrate 1 or the anode substrate 2 is rotated by 180° at predetermined time intervals, the positional relationship of the two substrates which face each other, is changed periodically, thus preventing non-uniformity of the activation treatment which occurs by deviation of the two substrates from the parallel relationship.

Here, Specific examples of numeral value employed in conducting the activation treatment in FIG. 1B will now be described.

In the embodiment of the present invention, the activation treatment was performed for several minutes in a depressurized atmosphere lower than 1 atm wherein vacuum-evacuation was performed first down to about 10⁻² Torr and then an activation gas (Ar or N₂) was supplied at a pressure of about 1 Pa or higher (preferably from about 10 to 2000 Pa (0.1˜20 Torr)). The distance between the anode substrate 2 and the cathode substrate 1 was maintained at 100 μm or less (preferably 50 μm) and the reverse bias voltage was set in the range from about 100 to 170 V.

Next, the uniformization method will be described below in conjunction with FIGS. 2A to 2C.

As illustrated in FIG. 2A, the cathode substrate 1 (obtained in FIG. 1C) manufactured through the activation method of FIGS. 1A to 1D and the anode substrate 2 are disposed to be faced to each other in a depressurized atmosphere (e.g., in a vacuum chamber), and a negative and a positive voltage of power supply E2 are respectively applied to the cathode conductor 12 and anode conductor 22. That is, forward bias voltage is applied to the cathode conductor 12 and the anode conductor 22. The power supply E2 may be a DC power supply or a pulse power supply.

When the forward bias voltage is applied to the two conductors, fibrous carbon portions 141 and 142 emit electrons. At this time, since the tips of the long carbon portion 141 is positioned to be closer to the anode conductor 22 than the tips of the short carbon portion 142, electrons are intensively emitted from the tips of the long fibrous carbon portion 141. Accordingly, the tip portions of the long fibrous carbon portion 141 are heated and lost by Joule heat, thereby the length thereof becomes substantially equal to that of the short fibrous carbon portion 142, as illustrated in FIG. 2B. Therefore, the lengths of the fibrous carbon portions 141 and 142 are uniformized, thus uniformizing the amount of electrons emitted from respective fibrous carbon portions 141 and 142.

In FIG. 2A, the uniformization treatment may be preformed in an atmosphere containing a reaction gas. In this case, the tips of the long fibrous carbon portion 141 are heated by Joule heat occurring due to electron emission and are further etched by reaction with the reaction gas, whereby the length of the long fibrous carbon portion 141 becomes the same as the length of the short fibrous carbon portion 142, as shown in FIG. 2B. The reaction gas may be any one or a mixture of two or more gases selected from O₂, H₂, CO₂, H₂O, air and the like. The reaction gas may be a diluted gas obtained by mixing a non-reactive gas (He, Ar, N₂ or the like) in O₂, H₂, CO₂, H₂O, air or the like. Thus, the reaction gas used for the uniformization method may be the same as the gas used in the activation method.

In FIG. 2A, the substrate 21 and the anode conductor 22 may be formed in one metal body same as the activation method of FIG. 1B or may be substituted with an anode substrate 2 having the anode conductor 22 and a phosphor 23 attached thereto, as shown in FIG. 2C. In case where the anode substrate 2 in FIG. 2C is used, the uniformization treatment may be performed in the process of manufacturing a fluorescent display tube or the like, as well as the activation method of FIG. 1.

In FIG. 2A, it is preferred that the cathode substrate 1 and the anode substrate 2 be disposed in a parallel relationship. However, even if they are not disposed in the parallel relationship, the cathode substrate 1 or the anode substrate 2 may be rotated by 180° at predetermined time intervals, thereby preventing non-uniformity occurring by a deviation of the substrates from the parallel relationship, as the case of the activation treatment.

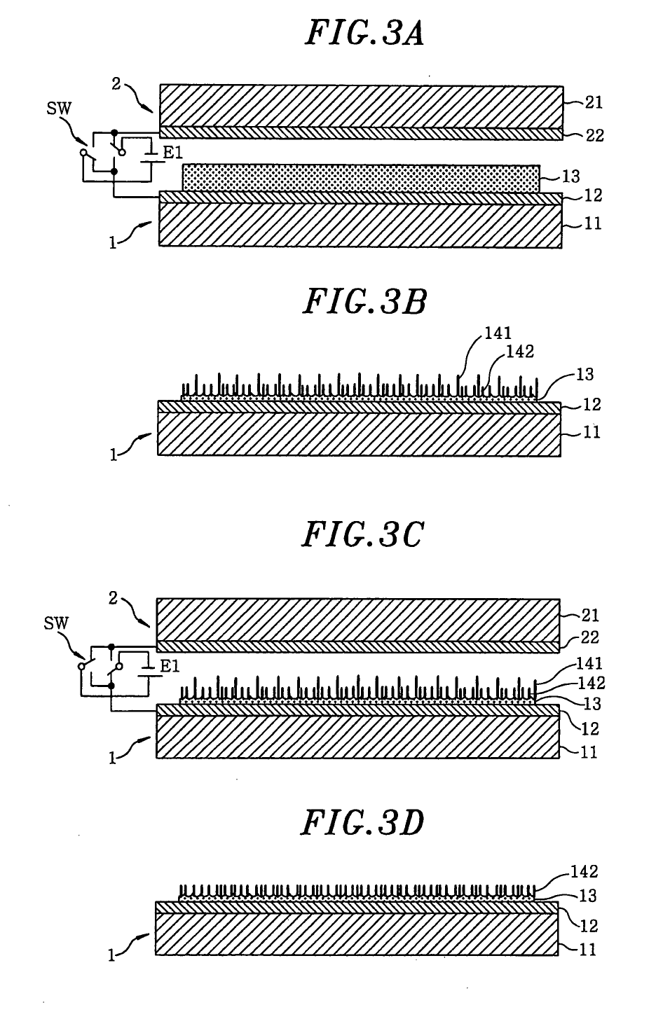

With reference to FIGS. 3A to 3D, the activation method and uniformization method of an electron emitting device in accordance with another embodiment of the present invention will be described.

FIGS. 3A and 3B illustrate the activation method and FIGS. 3C and 3D illustrate the uniformization method.

First, the activation method of FIGS. 3A and 3B is described below.

As shown in FIG. 3A, a cathode substrate 1 and an anode substrate 2 are disposed to be faced to each other in a depressurized atmosphere containing an activation gas. A positive voltage of power supply E1 is applied to a cathode conductor 12 via a switch SW, and a negative voltage is applied to an anode conductor 22 via the other switch SW. That is, a reverse bias voltage is applied to the two conductors. The gas used for the activation is the same as the activation gas in the first embodiment.

As seen in FIG. 3A, when the reverse bias voltage is applied to the cathode conductor 12 and the anode conductor 22, the activated cathode substrate 1 can be manufactured, as shown in FIG. 3B.

Then, the uniformization method will now be described below in conjunction with FIGS. 3C and 3D.

In FIG. 3C, the activated cathode substrate 1 is disposed with an anode substrate 2 to be faced to each other in a depressurized atmosphere containing a reaction gas. Switches SW are changed to the position shown in FIG. 3C, so that negative voltage of power E1 is applied to a cathode conductor 12 via a switch SW, and positive voltage is applied to an anode conductor 22 via the other switch SW.

That is, forward bias voltage is applied to the two conductors. The reaction gas used here is the same as the reaction gas in the first embodiment, and is also the same as the activating gas of FIG. 3A.

As shown in FIG. 3C, when the forward bias voltage is applied to the cathode conductor 12 and the anode conductor 22, the uniformized cathode substrate 1 in FIG. 3D can be manufactured as well as the first embodiment.

The activation method and the uniformization method of FIGS. 3A to 3D may be realized in a same process, by applying the reverse bias voltage or forward bias voltage to the cathode substrate 1 and the anode substrate 2 by converting the switches SW. Hence, according to the activation method and the uniformization method of FIGS. 3A to 3D, the number of processes may be decreased. In this case, when the activation treatment and the uniformization treatment are carried out by rotating the cathode substrate 1 or the anode substrate 2 by 180° at predetermined time intervals, the positional relationship of the two substrates, which face each other, is changed periodically, thereby preventing non-uniformity occurring by deviation of the two substrates from the parallel relationship. Moreover, as described in the second embodiment, when the activation treatment and the uniformization treatment of FIGS. 3A to 3D are performed in the process of manufacturing a fluorescent display tube, the number of processes may be further reduced.

Although the cathode conductor (cathode electrode) and the anode conductor (anode electrode) are applied to the activation method and the uniformization method described above, a grid (control electrode) may be applied thereto instead of the cathode and anode electrodes.

While the invention has been shown and described with respect to the embodiment, it will be understood by those skilled in the art that various changes and modifications may be made without departing from the scope of the invention as defined in the following claims.

What is claimed is:

1. A method for manufacturing an electron emitting device, comprising:
disposing a cathode substrate and an anode substrate to be faced to each other in a depressurized atmosphere containing an activation gas, the cathode substrate including a carbon layer formed by applying a paste having fibrous carbon and carbon impurities on a cathode conductor and drying the coated paste; and
applying a reverse bias voltage to the cathode conductor of the cathode substrate and an anode conductor of the anode substrate, thereby activating the carbon layer.

2. The method of claim 1, wherein the anode substrate is manufactured by forming the anode conductor on a glass substrate and attaching a phosphor to the anode conductor.

3. A method of manufacturing an electron emitting device, comprising:
disposing the cathode substrate the carbon layer of which is activated by the method of claim 1 and an another anode substrate to be faced to each other in another depressurized atmosphere;
and applying a forward bias voltage to the cathode conductor of said cathode substrate and an anode conductor of the another anode substrate, thereby uniformizing the fibrous carbon.

4. The method of claim 3, wherein said another anode substrate is manufactured by forming the anode conductor on a glass substrate and attaching a phosphor to the anode conductor.

5. The method of claim 3, wherein the fibrous carbon is uniformized by introducing a reaction gas into said another depressurized atmosphere.

6. The method of claim 5, wherein the depressurized atmosphere for uniformization is identical to the depressurized atmosphere for activation.

7. A method for manufacturing a fluorescent display tube, comprising: sealing and attaching the cathode substrate having the electron emitting device manufactured by the method of claim 3 to an anode substrate having an anode conductor and a phosphor attached thereto by using a sealing material.

8. A method for manufacturing a fluorescent display tube, comprising: sealing and attaching the cathode substrate having the electron emitting device manufactured by the method of claim 5 to an anode substrate having an anode conductor and a phosphor attached thereto by using a sealing material.
